(19) United States
(12) Patent Application Publication
(10) Pub. No.: US 2009/0020164 A1
(43) Pub. Date: Jan. 22, 2009

(54) Integrated and Detachable Float-valve-mounted Suction Plug

(76) Inventor: Robert Reed, Chula Vista, CA (US)

Correspondence Address: Karl M. Steins;Steins & Associates, Suite 120, 2333 Camino del Rio South, San Diego, CA, 92108, US

(21) Appl. No.: 11/879,967

(22) Filed: Jul. 19, 2007

(51) Int. Cl. E04H 4/16; F16K 1/00; F16L 55/11

(52) U.S. Cl. 137/270; 138/89

(57) ABSTRACT

An Integrated and Detachable Float-valve-mounted Suction Plug is disclosed. The float valve having an integrated suction plug provides dual functionality—the functionality of a conventional diverter valve, as well as the functionality to plug the skimmer assembly pump suction port. The detachable float-valve-mounted suction plug is configured to snap over the top of a conventional diverter device in order to add the skimmer assembly suction port plug functionality. Both versions will eliminate the need for a pool cleaning person to carry a bag-full of tennis balls or plugs. Each device is designed to stay with or be incorporated within the diverter inside of the skimmer housing. Finally, both embodiments allow the plugging of the pump suction port by flipping over the diverter and then replacing the diverter inside of the skimmer housing.

### BACKGROUND OF THE INVENTION

1. Field of the Invention

This invention relates generally to swimming pool equipage and, more specifically, to an Integrated and Detachable Float-valve-mounted Suction Plug.

2. Description of Related Art

Outdoor recreation has become a primary interest for most homeowners. One particularly desirable recreational feature continues to be the swimming pool (particularly in warm climates). In even the least-used swimming pool, there remains a continuing maintenance and cleaning requirement. In addition to the chemical balancing and removal of leaves, one particularly ponderous task is vacuuming the pool in order to remove leaves, algae and other materials stuck to or resting upon the bottom of the pool. The present invention addresses the vacuuming of the pool. First, we will review the basics of swimming pool design.

FIG. 1 is a perspective view of a conventional swimming pool 10. The depicted pool 10 is of the in-ground variety, because above-ground pools do not incorporate the same type of plumbing and equipment.

In virtually all swimming pools, the level of the water 12 is below the apron 14. At typically two or more locations around the pool 10 (and at more locations in larger pools), skimmer assemblies 16A and 16B are disbursed. Each assembly 16A, 16B has a mouth 18 positioned such that the waterline hits the middle of the mouth 18. Deck lids 20 can be removed in order to access the components contained within the assembly 16A, 16B, as depicted in FIG. 2.

FIG. 2 is an exploded perspective view of the skimmer assembly 16 of the pool of FIG. 1. The skimmer assembly 16 (which is the generic identification of elements 16A and 16B depicted above in FIG. 1) comprises a housing 22 (embedded under the apron). Water is pulled into the housing 22 through the mouth 18 and through a strainer (not shown) by the pump suction 26 line. In order to prevent air entering the pump suction 26 due to the water level in the pool being below the level of the mouth 18, most skimmer assemblies contain a diverter 30 device.

The diverter 30 will float atop the water inside the housing 22 when the housing 22 is filled with water up to the mouth 18 (which is the normal condition). If the water level within the housing 22 drops to a level below a shoulder seat 24 formed in the wall of the housing 22, the diverter 30 will drop down and seal to the seat 24. When the diverter 30 seals to the seat 24, it will prevent water (and air) from being drawn into the mouth 18 and into the pump action 26 line. What will occur is that pump suction 26 will draw water from a second port in the bottom of the housing 22—usually plumbed to the pool's bottom drain 28. Since the bottom of the pool will always have water, the bottom drain port 28 will provide a water supply to the pump suction 26 in order to prevent the pumping system from becoming airbound.

When a user wishes to vacuum the bottom of a swimming pool, they will typically turn on the suction pump. He or she will then remove the lid 20, screen (not shown) and diverter 30 from one skimmer assembly 16. The vacuum hose will then be attached to the pump suction 26 in that skimmer assembly 16.

Since the other skimmer assemblies are tied into the same pump suction line 26, the other assemblies' pump suctions 26 must be plugged so that the vacuum hose will receive full pump suction. The professional pool serviceperson will generally carry a bag of tennis balls—he or she will travel from skimmer assembly to skimmer assembly, where the strainer and diverter will be removed, and a tennis ball will be placed atop the pump suction 26 port of each skimmer assembly. The suction from the pump will hold the tennis balls in place while plugging that skimmer assembly's pump suction 26 port.

Elimination of the use of the tennis balls or other items to plug the pump suction 26. Besides being less than attractive for use in high-end swimming pools, they can tend to be hard to keep track of and a nuisance to carry around along with all of the other equipment needed. Since the focus of the present invention is the diverter 30, further detail related to the diverter 30 is provided below in the section labeled Detailed Description.

### SUMMARY OF THE INVENTION

In light of the aforementioned problems associated with the prior devices, it is an object of the present invention to provide an Integrated and Detachable Float-valve-mounted Suction Plug. The float valve having an integrated suction plug should provide dual functionality—the functionality of a conventional diverter valve, as well as the functionality to plug the skimmer assembly pump suction port. The detachable float-valve-mounted suction plug should be configured to snap over the top of a conventional diverter device in order to add the skimmer assembly suction port plug functionality. Both versions should eliminate the need for a pool cleaning person to carry a bag-full of tennis balls or plugs. Each device should stay with or be incorporated within the diverter inside of the skimmer housing. Finally, both embodiments should allow plugging of the pump suction port by flipping over the diverter and then replacing the diverter inside of the skimmer housing.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a perspective view of a conventional swimming pool;

FIG. 2 is an exploded perspective view of the skimmer assembly of the pool of FIG. 1;

FIG. 3 is a perspective view of a conventional diverter of the skimmer of FIGS. 1 and 2;

FIG. 4 is a cutaway side view of the diverter of FIG. 3;

FIG. 5 is a perspective view of a preferred embodiment of a diverter having an integral suction plug of the present invention;

FIG. 6 is a cutaway side view of the device of FIG. 5;

FIG. 7 is a perspective view of a preferred embodiment of a diverter cap having an integral suction plug of the present invention;

FIG. 8 is a cutaway side view of the diverter of FIGS. 5 and 6 installed in a conventional skimmer housing; and

FIG. 9 is a cutaway side view of the diverter cap of FIG. 7 installed in a conventional skimmer housing.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide an Integrated and Detachable Float-valve-mounted Suction Plug.

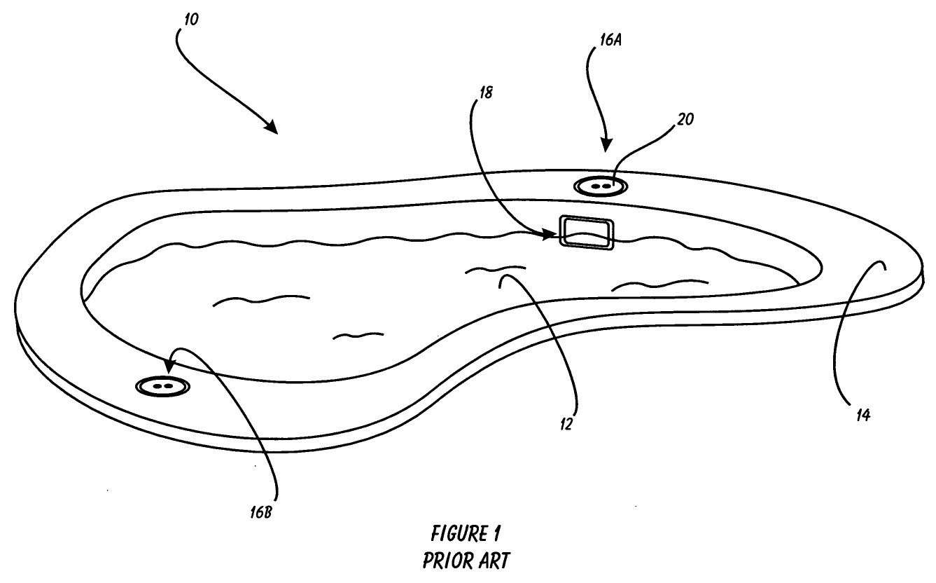

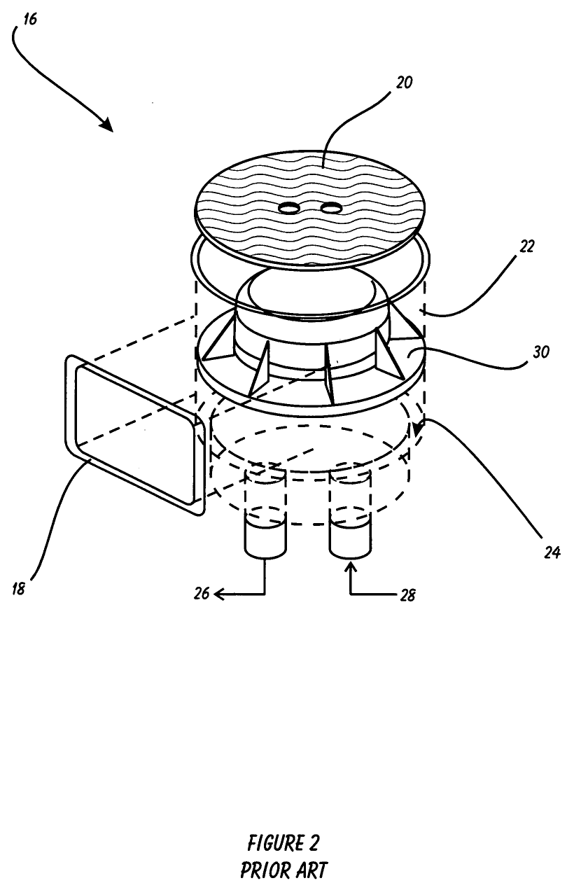

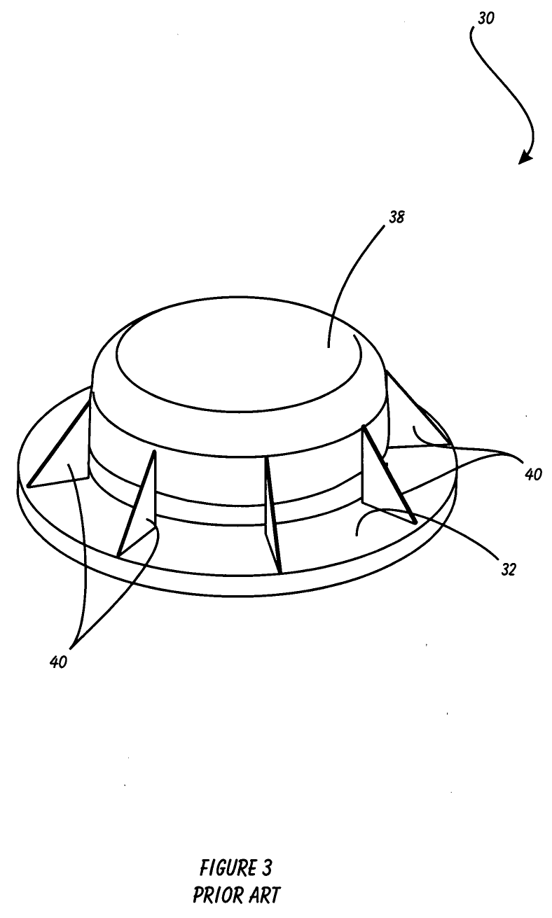

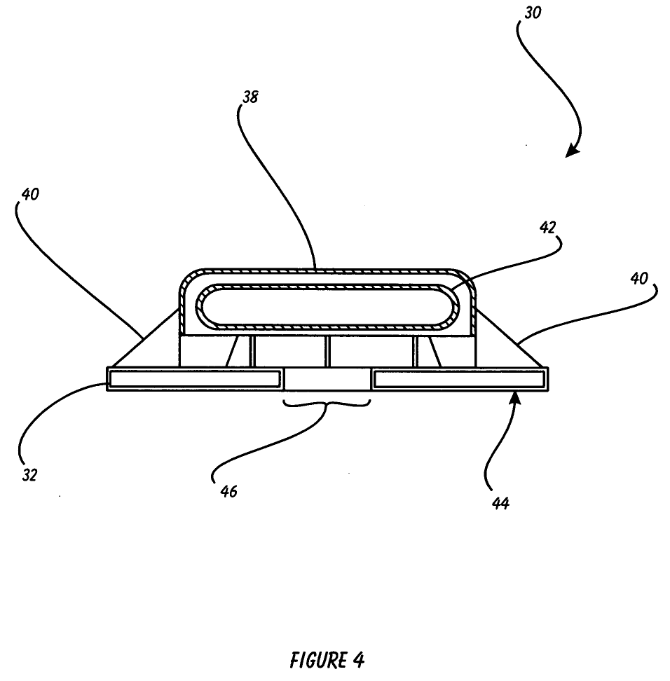

The present invention can best be understood by initial consideration of FIG. 3. FIG. 3 is a perspective view of a conventional diverter 30 of the skimmer of FIGS. 1 and 2. The diverter 30 is made from chemical-resistant plastic so that it will not be severely damaged by the chlorine-enriched water of the typically swimming pool. The diverter 30 is defined by a ring-shaped base 32 and an upper dome 38 suspended over the base 32 by a plurality of structural fins 40 extending between the base 32 and dome 38. FIG. 4 provides additional detail of this prior device.

FIG. 4 is a cutaway side view of the diverter 30 of FIG. 3. The base 32 is defined by a bottom surface 44 through which a diverter aperture 46 may or may not be provided. The diverter aperture 46 can be selectively closed or opened in order to either decrease or increase the amount of water that will flow through it; it essentially operates as a bypass to the diverter's 30 function. If the aperture 46 is opened fully, it will allow water flow from atop the diverter 30 even when the bottom surface 44 is sealed against the seating shoulder of the skimmer housing (see FIG. 2). If the aperture 46 is completely closed, then all flow to the pump suction will have to come from the pool bottom drain once the bottom surface 44 is sealed against the seating shoulder (see FIG. 2).

A float member 42 is contained within the diverter 30 by the upper dome 38 and the fins 40. The float member 42 causes the diverter 30 to float, and further serves to seal off the diverter aperture 46 (from the top) when the water level has dropped below the level of the top of the base 32 (again, to prevent air from entering the pump). Having now examined the details of the conventional diverter, we can move on to discuss the present invention.

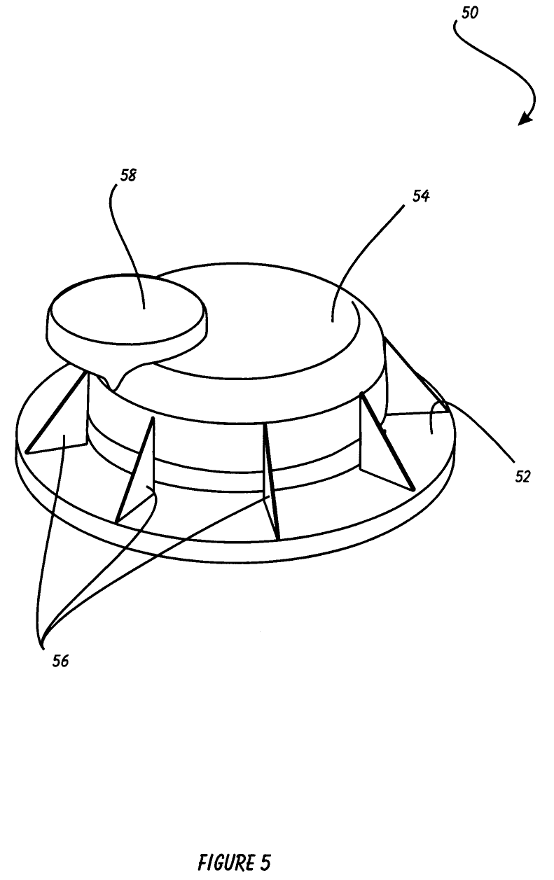

FIG. 5 is a perspective view of a preferred embodiment of a diverter having an integral suction plug 50 of the present invention. The dual-function diverter 50 of the present invention is designed to be exchanged with the prior art diverter wherever the prior art diverter is in use. The dual-function diverter 50 provides the same feature as the prior diverter, plus it is configured to replace the tennis ball or other device to plug the pump suction.

The dual-function diverter 50 has a base 52, an upper dome 54, and most likely a plurality of fins 56 interconnecting the two (although other designs might be created).

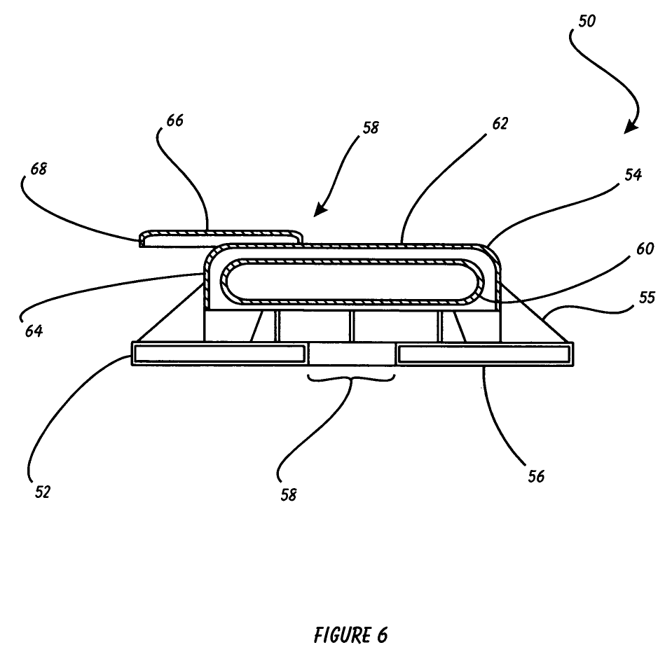

What is unique about the dual-function diverter 50 is that the top surface of the upper dome is not a simple, smooth surface. Instead, there is a plug protrusion extending upwardly from an outer edge of the upper dome 54. As will discussed more fully below in connection with other drawing figures, the plug protrusion is shaped and located so that if the dual-function diverter 50 is flipped over and placed in the skimmer housing, it can be aligned to plug off the pump suction port. FIG. 6 provides additional detail regarding the new device.

FIG. 6 is a cutaway side view of the device 50 of FIG. 5. As with the prior diverter, this device 50 has a base 52 defined by a diverter aperture 58 penetrating the bottom surface 56. The float 60 is captured within the device by the fins 55 and the bottom surface of the upper dome 54.

The dome top surface 62 is defined by a plug protrusion 58 extending upwardly therefrom. As seen, the side wall 68 of the plug protrusion 58 does partially extend beyond (or overhangs) the side wall 64 of the upper dome 54. The top surface 66 of the protrusion is at a level that is higher than that of the upper dome 54 so that (when it is flipped upside down), the protrusion 58 can reach further down into the bottom of the skimmer housing so that it can be aligned to plug the pump suction port. If the protrusion 58 is accidently placed over the bottom drain port, it will simply pop out once a suction exists at the pump suction port.

By providing both a plug for the pump suction as well as the diverter functionality to prevent the pump from becoming airbound, the device 50 eliminates the need for the pool serviceperson to carry around a bag of tennis balls in order to vacuum the pool, since the diverter 50 is already in each skimmer housing, ready for use.

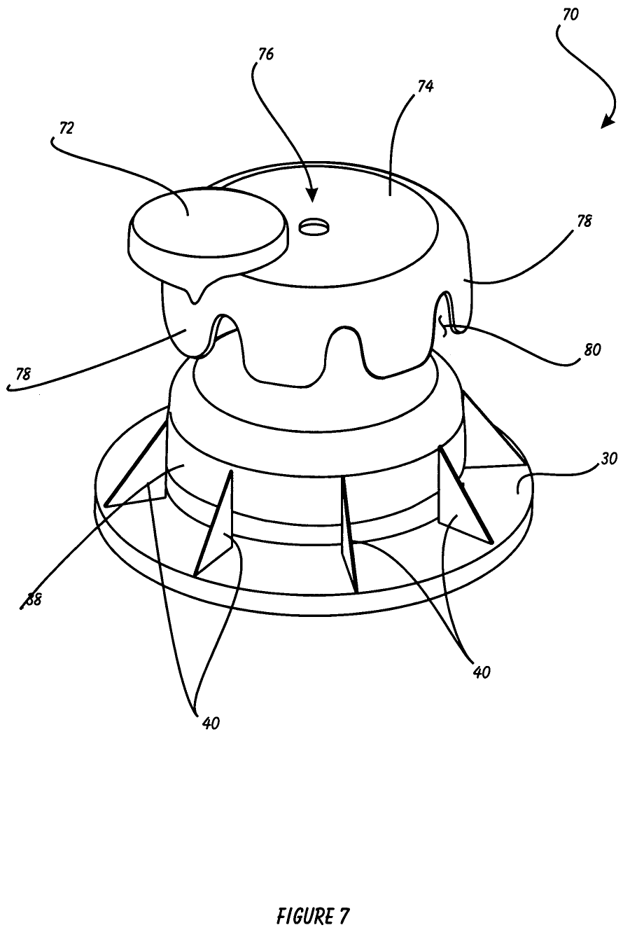

In order to avoid the need to dispose of existing diverters already installed in swimming pools, the inventor has created a modified version of the present invention that serves to convert existing diverters so that they have the same functionality as the dual-function diverter discussed above. This new design is depicted below in FIG. 7.

FIG. 7 is an exploded perspective view of a conventional diverter and a preferred embodiment of a diverter cap 70 having an integral suction plug of the present invention. As discussed above in connection with FIGS. 3 and 4, the diverter 30 depicted here has an upper dome 38 and a plurality of fins 40. The cap 70 is designed to snap over the top of the upper dome 38 so that the resultant assembly will essentially have the same features as the device of FIGS. 5 and 6, without the need to dispose of perfectly serviceable diverter units.

The cap 70 is defined by its own upper dome 69 and a side wall 78, in this case made the side wall 78 is defined by a plurality of notches 80 formed therethrough so that the individual notches 80 will align with the fins 40 on the diverter 30 when the cap 70 is snapped thereover.

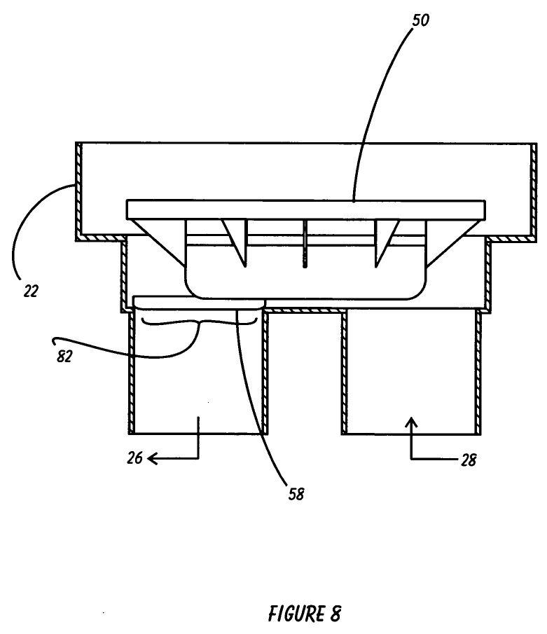

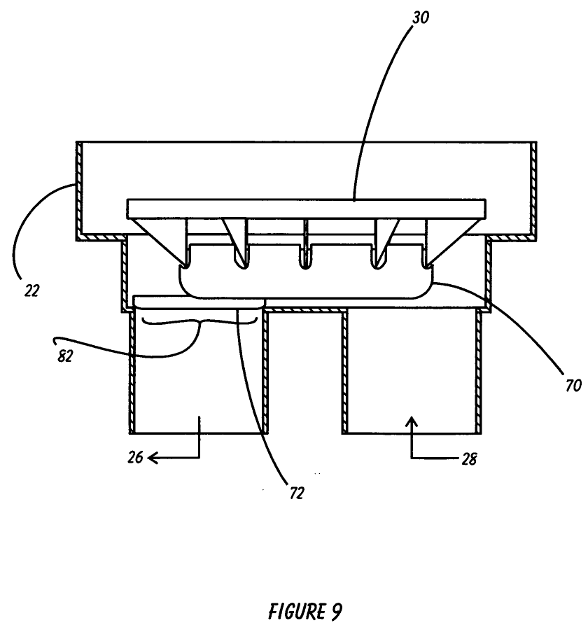

A plug protrusion 72 protrudes upwardly from the top surface 74 of the upper dome 69, in essentially the same orientation as did the first embodiment of the invention describe above in connection with FIGS. 5 and 6. It may be desirable that a central aperture 76 be located atop the top surface 74 of the upper dome 69 in order to relieve any suction or pressure caused between the cap 70 and the diverter 30 when the cap 70 is either being snapped onto or off of the diverter 30. If we now turn to FIGS. 8 and 9, we can examine how these two embodiments are actually used.

FIG. 8 is a cutaway side view of the diverter 50 of FIGS. 5 and 6 installed in a conventional skimmer housing 22. As can be seen, the diverter 50 has been flipped upside down and then reinserted into the skimmer housing 22. It has also be rotated so that the plug protrusion 58 is aligned with the pump suction port 82. This will plug the suction line to the pump 26 so that one of the other skimmer assemblies can be used to attach the vacuum hose. FIG. 9 shows how the other embodiment of the present invention is used.

FIG. 9 is a cutaway side view of the diverter cap 70 of FIG. 7 attached to a prior art diverter 30, and then installed in a conventional skimmer housing 22. As can be seen, the cap 70 has been snapped onto the top of the diverter 30. The diverter 30 has then been flipped over and inserted upside-down into the skimmer housing 22 so that the plug protrusion 72 is covering the suction port. As with the previously-discussed embodiment, this cap version will also stop flow to the pump suction 26 so that one of the other skimmer assemblies can be used for the vacuum hose connection.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A device for insertion into a pool skimmer housing, comprising:
an upper dome portion defined by a top surface; and
a plug protrusion extending upwardly from said top surface.

2. The device of claim 1, wherein said plug protrusion defines a generally circular shape.

3. The device of claim 2, wherein said upper dome defines a side wall extending downwardly from said top surface.

4. The device of claim 3, wherein said side wall has notches formed therethrough in spaced relation around a periphery of said side wall.

5. The device of claim 3, further comprising a base attached in spaced relation below said upper dome.

6. The device of claim 5, wherein said base and said upper dome are interconnected by fins, said fins in relative spaced relation.

7. The device of claim 6, further comprising a float element captured between said upper dome, said base and said fins.

8. A plug for a plumbing port, the plumbing port defining a diameter, the plug comprising:
an upper dome defining a diameter at least twice as large as said port diameter and a top surface; and
a plug protrusion extending upwardly from said top surface of said upper dome.

9. The plug of claim 8, wherein said plug protrusion defines a diameter, said plug protrusion diameter being greater than said port diameter but less than said upper dome diameter.

10. The plug of claim 9, wherein said plug protrusion defines a generally circular shape.

11. The plug of claim 10, wherein said upper dome defines a side wall extending downwardly from said top surface.

12. The plug of claim 11, wherein said side wall has notches formed therethrough in spaced relation around a periphery of said side wall.

13. The plug of claim 11, further comprising a base attached in spaced relation below said upper dome.

14. The plug of claim 13, wherein said base and said upper dome are interconnected by fins, said fins in relative spaced relation.

15. The plug of claim 14, further comprising a float element captured between said upper dome, said base and said fins.

16. A plug for a pump suction port of a swimming pool skimmer assembly housing, the pump suction port defining a diameter, the plug comprising:
an upper dome defining a diameter that is larger than said port diameter, a top surface, and a side wall extending downwardly from said top surface; and
a plug protrusion extending upwardly from said top surface of said upper dome, said plug protrusion defining a diameter that is less than said port diameter, but greater than said upper dome diameter.

17. The plug of claim 16, wherein said plug protrusion defines a generally circular shape and a flat bottom profile, said plug protrusion extending from said top surface in a direction radially outward from a center of said upper dome.

18. The plug of claim 17, wherein said plug protrusion defines a proximal side and a distal side, said proximal side juxtaposed over said top surface of said upper dome and said distal side cantilevered beyond said side wall.

19. The plug of claim 18, wherein said side wall has notches formed therethrough in spaced relation around a periphery of said side wall.

20. The plug of claim 18, further comprising a base attached in spaced relation below said upper dome.
